(19) United States
(12) Patent Application Publication
(10) Pub. No.: US 2003/0145106 A1
(43) Pub. Date: Jul. 31, 2003

(54) System and method for directing wireless data packet traffic

(75) Inventor: Kirk B. Brown, Tracy, CA (US)

Correspondence Address: HOGAN & HARTSON LLP, ONE TABOR CENTER, SUITE 1500, 1200 SEVENTEEN ST., DENVER, CO, 80202, US

(73) Assignee: Sun Microsystems, Inc.

(21) Appl. No.: 10/062,324

(22) Filed: Jan. 31, 2002

(51) Int. Cl. G06F 15/173; G06F 15/16

(52) U.S. Cl. 709/238; 709/230

(57) ABSTRACT

Various methods and systems for handling and directing wireless packet data traffic is disclosed. In one embodiment, the system is a data switching system that includes a first data port interface coupled to a first data communication port, a second data port interface coupled to a second data communication port, and a data packet parsing engine responsive to the first data port interface and the second data port interface. The data packet parsing engine includes a wireless data packet evaluation routine to retrieve and evaluate content contained within the wireless data packet. In another embodiment, a method of processing wireless data traffic is provided. The method includes receiving the wireless data traffic at a gateway, evaluating a data packet within the wireless data traffic at the gateway to determine at least one of language information, user browser type information, and data content type information, and sending a data request to a particular computer server. The particular computer server is determined based on at least one of the language information, the user browser type information, and the data content type information.

### BACKGROUND

1. Field of the Invention

The present invention relates to systems and methods for directing wireless data traffic.

2. Description of the Related Art

Several protocols used for transport between a fixed internet protocol (IP) network and a telecommunications signaling or wireless network require transcoding from one type of packet data unit (PDU) to another. This transcoding process not only consumes computer resources and time, but there is also additional information contained in each PDU that is usually processed by middleware logic, adding to network delay.

The wireless application protocol (WAP), such as WAP version 1.1, draws heavily on existing internet standards, like HTML and TCP/IP. Yet WAP itself is not based on current internet standards. WAP originated from a proprietary protocol that has since been managed by a standards body. The protocol depends upon a gateway server to translate the WAP protocol into http over TCP/IP so the data to and from a wireless WAP device can communicate with other standard internet/intranet system components. WAP enabled wireless devices require a WAP gateway to function or to access the IP network. A gateway is an intermediary for other servers and services.

As user agent populations increase (such as in the case of further deployment of Internet phones), millions of accesses may have to be supported through a single WAP gateway. Currently, internet phones hard-code a single WAP gateway's internet protocol (IP) address used by the phone to access wireless data. If a service was deployed to a large U.S. city, it would be conceivable that millions of cell phone users would generate tens of millions of requests a day through a single gateway system. Current gateway capacity is well below these types of capacity requirements.

Accordingly, there is a need for an improved system and method of directing wireless data traffic.

### SUMMARY

The present invention relates to a system and method for directing wireless data packets. In one embodiment, the system is directed to an apparatus for placement in a communication path between a wireless client device and a plurality of computer network elements. The apparatus includes a data port configured to receive data in accordance with a wireless data protocol and a redirection engine coupled to inspect the received data and direct corresponding data in accordance with the wireless data protocol to a particular one of the plurality of computer network elements.

In another embodiment, the system includes a wireless gateway, a first gateway cluster, and a second gateway cluster. The first gateway cluster is associated with a first group of computer servers, each of the computer servers in the first group of computer servers having a different internet protocol address. The second gateway cluster is associated with a second group of computer servers. The wireless gateway is configured to decode previously encoded wireless data traffic packets to create decoded data packets to be sent to a selected computer server within one of the first and the second group of gateway clusters.

In another embodiment, a method of processing wireless data traffic is provided. The method includes receiving the wireless data traffic at a virtual gateway, evaluating a data packet within the wireless data traffic at the virtual gateway to determine at least one of language information, user browser type information, mobile device profile, and data content type information, and sending a data request to a particular computer server that is located at a physical internet protocol address. The virtual gateway has a virtual internet protocol address, and the particular computer server is determined based on at least one of the language information, the user browser type information, the mobile device profile, and the data content type information.

In another embodiment the system is a data switching system that includes a first data port interface coupled to a first data communication port, a second data port interface coupled to a second data communication port, and a data packet parsing engine responsive to the first data port interface and the second data port interface. The data packet parsing engine includes a wireless data packet evaluation routine to retrieve and evaluate content contained within the wireless data packet.

### BRIEF DESCRIPTION OF THE DRAWINGS

FIG. 1 is a block diagram that illustrates a system for directing wireless data.

FIG. 2 is a block diagram of another system for directing wireless data.

FIG. 3 is a diagram that provides further details of a wireless data system.

FIG. 4 is a flowchart that illustrates a method of processing wireless data.

FIG. 5 is a flowchart that illustrates another method of processing wireless data.

FIG. 6 is a general diagram that illustrates a system for switching wireless data.

FIG. 7 is a block diagram that further illustrates the system of FIG. 6.

The use of the same reference symbols in different drawings indicates similar or identical items.

### DETAILED DESCRIPTION OF THE DRAWINGS

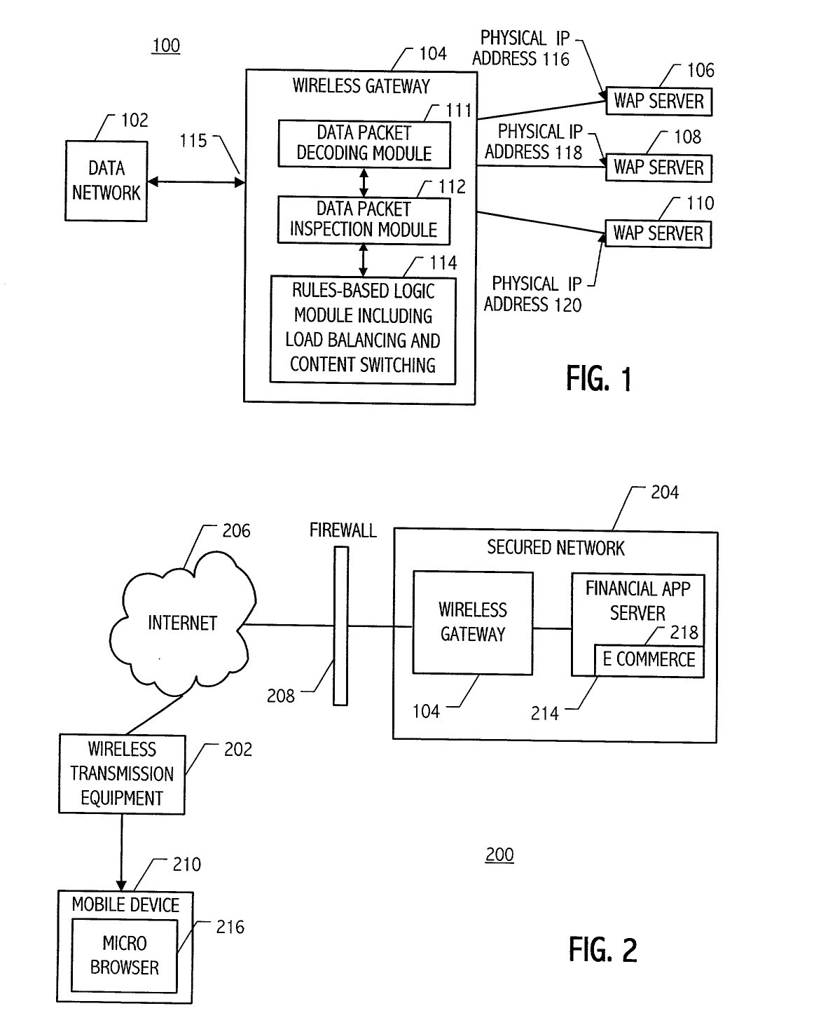

Referring to FIG. 1, an illustrative system 100 for directing wireless data traffic is shown. The system 100 includes a virtual wireless application protocol (WAP) gateway 104, a data network 102, and a plurality of illustrative WAP servers 106, 108, and 110. The wireless gateway 104 includes a data packet decoding module 111 for binary decoding, a rules-based logic module 114 for handling WAP) load balancing, and a content switching and data packet inspection module 112. While the decoding module 111, logic module 114, and inspection module 112 have been shown separately, the associated functionality of these modules may be integrated in one or more software programs.

The data network 102 is a distributed computer network such as the Internet. The wireless gateway 104 is coupled to the data network 102 via a data communication link. The wireless gateway 104 has a computer network input 115 at an IP address. The IP address is used to identify a network location for routing packets via the data network 102. The computer network input 115 includes a data port configured to receive wireless data traffic. The wireless gateway 104 is communicatively coupled to each of the WAP servers 106, 108, and 110. WAP server 106 has a physical IP address 116, WAP server 108 has a physical IP address 118, and WAP server 110 has a physical IP address 120. While three servers 106, 108, 110 have been shown for illustrative purposes, it should be understood that the WAP gateway 104 may connect to one or to many more servers or other network elements based on a particular network configuration.

During operation, many different wireless data packet messages may be received at the wireless gateway 104. These wireless data packet messages are evaluated by the packet inspection routine using a variety of rules to determine proper packet redirection. Based on information retrieved from inspecting the packet, and based on the specific rules of redirection programmed into the logic module 114, a particular received data packet may be redirected and then re-routed to one of many particular network elements, or a dedicated server running a specific service, such as to WAP servers (106, 108, 110), to the associated designated physical IP address. In a reverse data transmission scenario, a data packet from a WAP server, such as WAP server 108, is sent to the wireless gateway 104. The data packet received at the wireless gateway 104, may then be binary encoded and converted to WAP protocol for further communication via the data network 102 toward a final destination, such as a mobile device that has implemented the WAP protocol.

Referring to FIG. 2, another illustrative system 200 for handling and directing wireless data traffic is shown. In this embodiment, this system 200 includes a mobile device 210, wireless transmission equipment 202, Internet communication network 206, firewall 208, and a secured network 204. The mobile device 210 may be a handheld device such as a modified cellular phone or personal digital assistant (PDA) that includes a processor executing software that performs a micro-browser function 216. The wireless transmission equipment 202 may include commercially available wireless infrastructure equipment such as base stations, radio towers and other control and communication switching equipment. The secured network 204 includes the wireless gateway 104 and a financial application server 214. The financial application server may be a computer server having a particular financial software application loaded thereon. For example, the financial application may include electronic commerce software 218 to enable product purchases by a user of the wireless device 210. The secured network 204 may be contained within a financial institution, such as a trusted financial provider including banks, insurance companies, and other financial service companies. With the system 200, the wireless gateway 104 is located behind firewall 208.

One of the functions of the wireless gateway 104 is to convert WAP data packets into HTTP internet data format. During this conversion process, the wireless gateway 104 software decodes the WAP data packet thereby converting the underlying data information to an unencrypted form. Since the wireless server momentarily has access to non-encrypted data, it is advantageous that this conversion process occurs behind the firewall 208 and within a secured network 204 of a trusted institution such as a financial institution. An example of sensitive information may include personal user information, such as the user's credit card number. By allowing access to such sensitive information within the secured network 204, privacy issues relating to such information may be adequately addressed. For example, a user of the mobile device 210 may feel more comfortable to make an e-commerce purchase if the user knows that their credit card information is handled by a bank within a secured computer network.

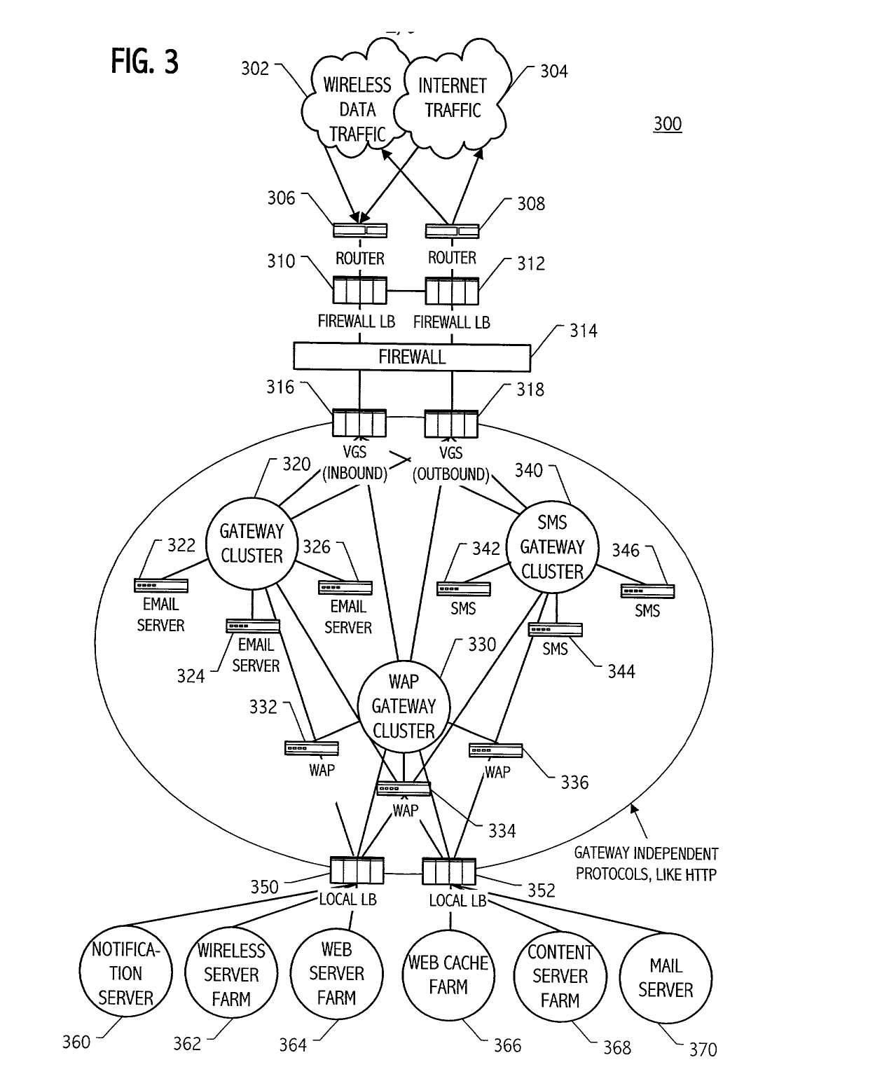

Referring to FIG. 3, another particular implementation of a system 300 for directing wireless data traffic is illustrated. System 300 includes a wireless data traffic network 302, an Internet traffic network 304, firewall 314, virtual gateway servers (VGS) 316, 318, local load balancing servers 350, 352, and a variety of gateway clusters 320, 330, and 340. The firewall 314 is coupled to firewall load balancing servers 310 and 312. These servers 310 and 312 are coupled through routers 306, 308 for access and communication with wireless data traffic 302 and internet traffic 304. As shown, the firewall 314 is also coupled to the inbound VGS 316 and the outbound VGS 318. The inbound VGS 316 is coupled to the first gateway cluster 320, to the second gateway cluster 330 and to the third gateway cluster 340. The first gateway cluster 320 is an electronic mail, short message transport protocol (SMTP) gateway cluster. The second gateway cluster is a WAP gateway cluster, and the third gateway cluster is a short message service (SMS) gateway cluster.

The first gateway cluster 320 is coupled to a group of email servers 322, 324, and 326. Each of these servers 322-326 includes a data storage repository and has data communications capabilities. Similarly, WAP gateway cluster is coupled to WAP servers 332, 334, and 336 and the SMS gateway cluster 340 is coupled to various SMS servers 342, 344, and 346.

Each of the local load balancing servers and routers 350, 352 is connected to each of the three gateway clusters 320, 330, and 340. The communication coupling between the VGS 316, 318, the gateway clusters 320, 330, 340, and the local load balancing servers 350, 352 is over gateway independent industry standard protocols such as HTTP or TCP/IP, well-known for data communication. The local load balancing server 350 has access to a notification server 360, a wireless server farm 362 and a web server farm 364. The local load balancing server 352 has access to a web cache farm 366, a content server farm 368, and mail server 370. Each of the WAP servers coupled to the WAP gateway cluster 330 has a physical IP address to receive and transmit computer network data packets. Each of these addresses is a physical and fixed IP address. As an example, WAP server 332 may have IP address 129.65.37.2, WAP server 334 may have IP address 129.65.37.3, and WAP server 336 may have IP address 129.65.37.4.

During operation, various different types of wireless data packets are initially routed by the router 306 to the VGS 316 at a virtual IP address. Depending on the type of packet, the language and the context of the packet and based on particular data traffic loading, the data packet is then routed to a particular physical IP address. In this manner, the VGS 316 may provide load balancing and proper redirection to a designated gateway cluster and thereby provide virtual capacity and intelligent fast and direct data communication. The VGS 316 may be mapped to multiple physical IP addresses for WAP gateway servers to produce a cluster that offers reliability and that can handle capacity on demand. In addition, VGS 316 can perform WAP header and PDU inspection used for connection and redirection to backend services based on a whole host of criteria, for example: micro-browser type (micro-browser, JAVA, HDML, etc.); redirection based on service request (email, calendar, content), redirection based on language (English, German, Chinese, Spanish, etc.); redirection based on domain name; redirection based on cellular positioning (GPS, triangulation), and redirection based on device characteristics (color, display size, multimedia capabilities, etc.).

In FIG. 3, three data protocols that are common to wireless services are shown: SMTP (or email), SMS (or messaging) and WAP. A set of programmable rules may be used for detecting key strings in each PDU of each protocol. These rules may be embedded within a parsing engine of a switch that implements functionality of the VGS 316, 318. Routing decisions would therefore be more intelligent and in many cases the traversal path of each PDU could be predetermined to provide more efficient servicing of each PDU request. Back-end services such as notification or content delivery could be efficiently handled “inband” versus slower out of band methods, since the parsing engine on the switch could perform middleware-like decision making, but at dramatically faster speed.

The communication between a wireless WAP device and the VGS 316, 318 may use UDP packets that contain binary WAP encoding as sequential octets. Also, the binary codes used may be unique per bearer service. The data packet transport may follow HTTP 1.1 semantics, like request/reply methods and headers, content typing, language typing and asynchronous requests.

The programmable rules-based load balancing logic within the VGS 316 may be similar to the illustrative script below. In this example, many types of wireless traffic (WAP, iMode, J2ME or any other micro-browser source traffic) is pointed to a single virtual IP address and based on language, browser type and content type, a redirect request to a physical IP address (a server or gateway or other computer network element dedicated to servicing a particular language, browser type or content type) can be made.

To follow this script example, a developer would first configure the default file for the root web server directory to be a program or script. In the script that serves the root URL, a check is made to the USER_AGENT and ACCEPT headers in the HTTP request to determine the browser type, browser version, and supported languages. Using this information, one can branch and serve the appropriate content. The following detailed example shows one way of serving a different file based on the native language of the requesting browser.

Although UP. Browser 4.x is a native wireless markup language (WML) browser, either WML or HDML content may be used for phones running UP.browser 4.x as long as the WAP Gateway is a Phone.com UP.Link Server. Here is the example script language:

“#!/usr/up/tools/bin/per15
$accept − $ENV {“HTTP_ACCEPT”};
$agent = $ENV {HTTP_USER_AGENT”};
if ($agent =˜ “UP”) {
if (accept =˜ “wmlscript”) {
# UP.Browser 4.x (WML)
print “location:http://www.mysite.com/index.wml\n\n”;
exit (0);
} else {
#UP.Browser 3.x or earlier (HDML)
print “Location: http://www.mysite.com/index.hdml\n\n”;
exit (0);
}
} else {
#Not a Phone.com Browser (HTML)
print “Location: http://www.mysite.com/index.html\n\n”;
exit (0);
}”

The above script directs data packets to either a WML server, a HDML server, or an HTML standard server based on an inspection of the browser type and version information in a data packet.

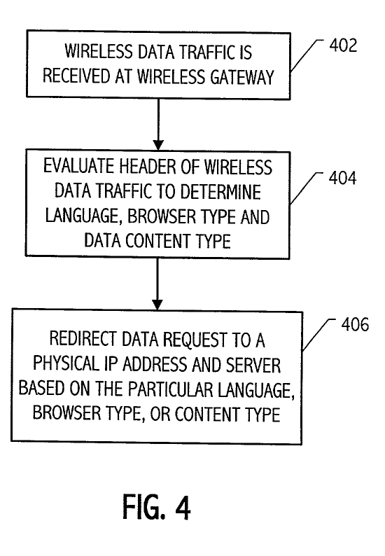

Referring to FIG. 4, an illustrative method of operation for a system such as those shown in FIGS. 1 through 3 is shown. In accordance with this method, wireless data traffic is received at a wireless gateway, such as a wireless gateway, at step 402. A header of a wireless data traffic packet is then evaluated to determine a particular language, browser type and data content type for such packet, at 404. A redirect data request is sent to a physical IP address and the associated server based on the particular language, browser type or content type of the header for such packet, at 406.

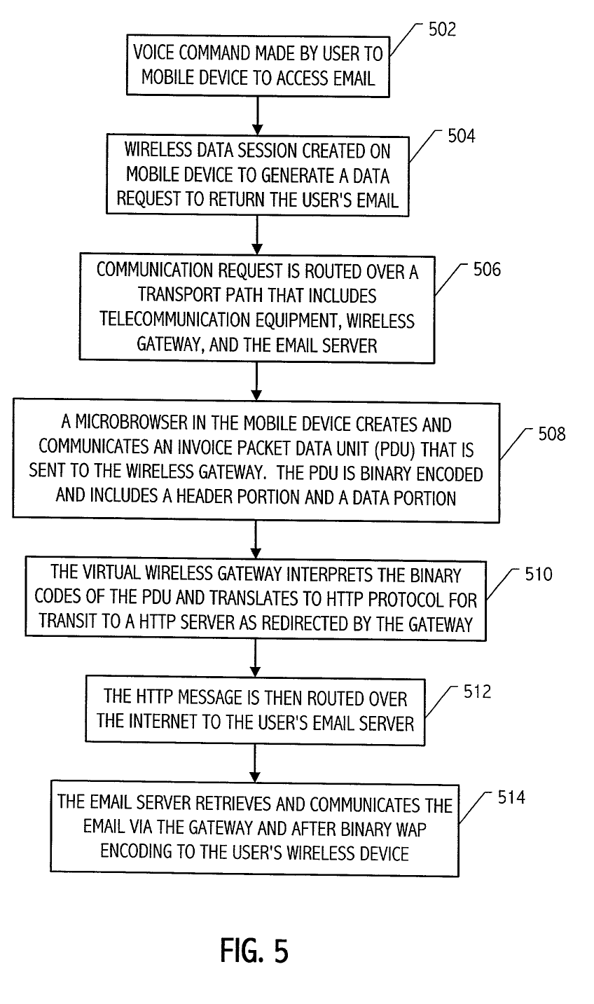

Referring to FIG. 5, another embodiment of a method for use within a wireless data traffic system is shown. At 502, a voice command is made by a user to a mobile device to access the user's e-mail. A wireless data session is created on the mobile device to generate a data request to return the user's e-mail, at 504. The data communication request is then routed over a transport path that includes various telecommunication and data communication equipment at 506. The transport path includes a virtual IP wireless gateway and a final destination e-mail server. A micro-browser within the mobile device creates and communicates an invoke packet data unit (PDU) that is sent to the virtual IP address of the wireless gateway, at 508.

An example of an encoded invoke PDU may look like:

“0800 20b7 acc6 0000 0ed2 3022 0800 4500 007c 1055 0000 8011 45d1 8192 70d2 8192 7054 c34c 23f0 0068 edaf 04402268 7474 703a 2f2f 7777 772e 7375 6e2e 636f 6d2f 656d 6179 6c2f”

This example invoke PDU has several header elements. The first three words “0800 20b7 acc6” identify the destination MAC address. The next three words “0000 0ed2 3022” identify the source MAC address. The next three words “0800 4500 00” describe the Ethernet type as IP and the type of service as IPv6.

The inspection process can retrieve source port and destination port number and can retrieve a request for content called a GET instruction (see HEX value 40 underlined, followed by an encoded URL, such as “68 7474 703a 2f2f 7777 772e 7375 6e2e 636f 6d2f 656d 6179 6c2f” indicating “http://www.sun.com/email/”. (Sun Microsystems corporate email server.)

In contrast to conventional data packet routing, such as: Mobile Device z,900 WAP GW z,900 HTTP Server z,900 Application Server z,900 Email Server, the proposed system handles data packets by routing: Mobile Device z,900 Wireless GW z,900 HTTP Server z,900 Email Server. Accordingly, the time consuming process of routing and processing at the application server, including the middleware logic, may be avoided.

Referring again to FIG. 5, the virtual wireless gateway interprets the binary codes of the PDU and translates the data to HTTP protocol for transmission to an HTTP server as redirected by the gateway, at 510. The message is then routed over the Internet to the user's e-mail server, at 512. The destination e-mail server retrieves and communicates the requested e-mail via the virtual gateway, at 514. As part of the return communication and retrieval of the user's e-mail, binary WAP coding is performed so that the WAP protocol may be used to transmit the e-mail message to the user's wireless device. Thus, the illustrated method may be used by a mobile device user to request and receive access to the user's e-mail via a virtual wireless gateway and using the Internet.

As an example use of such a system and method, if a user is in another country roaming and trying to get his corporate email, based on information contained on his phone that is encoded into the invoke PDU, the user would be able to hop directly to the correct WAP GW because the load balancing server in the other country could redirect the request to the home WAP gateway. These routing decisions may be specified as rules within a data packet parsing engine of a layer 2 IP switch that is running on a custom ASIC chip that is specifically designed to quickly process and forward packets.

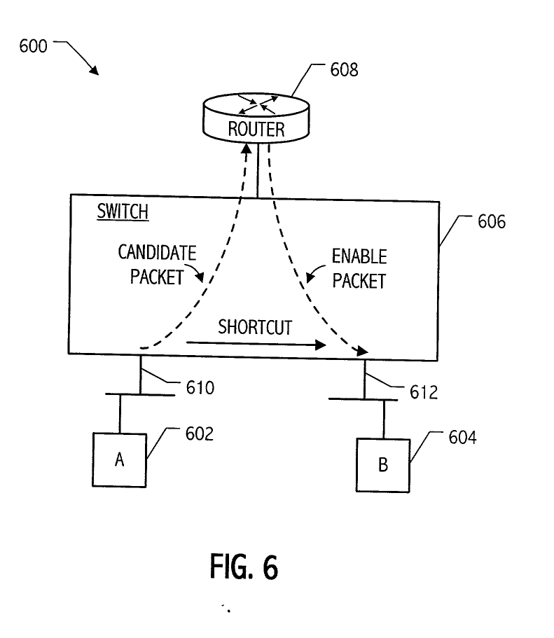

Referring to FIG. 6, an illustration of a switch and router system that may be used to implement the above-described methods is shown. The system 600 includes data switch 606, router 608, a first end station 602, and a second end station 604. The data switch 606 has a first port 610 to interface to the first end station 602 and a second port 612 to interface to the second end station 604. During operation, a data packet received at the first port 610 may be forwarded to the router 608 for destination determination and then received at the switch 606 and further forwarded to the second end station 604 via the second port 612. Alternatively, depending on logic within the switch 606, a shortcut process may be used where a data packet received at port 610 may be directly routed to port 612 for forwarding to end station 604. The shortcut process determination may be made by applying the above-illustrated methods of inspecting received data packets and determining direct routing locations based on various content of the data packet and redirection rules-based techniques.

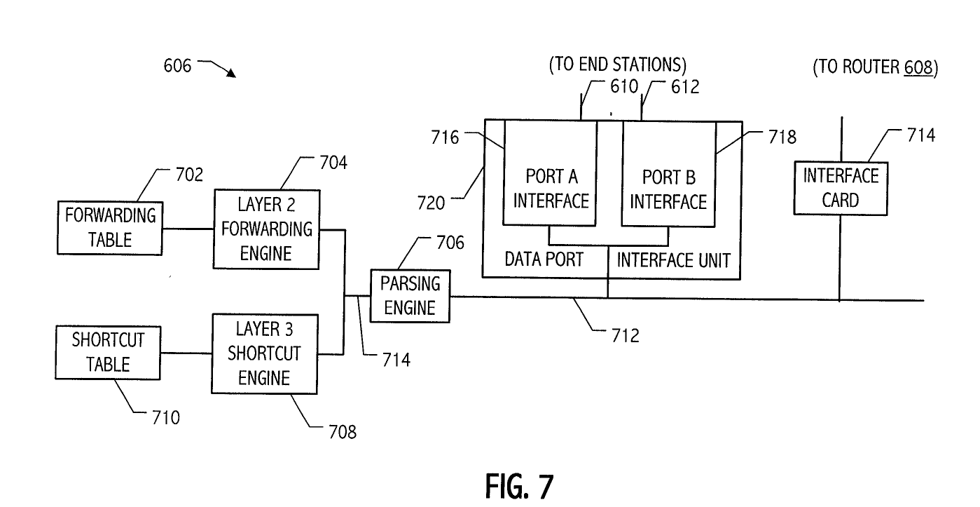

Referring to FIG. 7, a more detailed illustration for implementing the data switch 606 is shown. In this embodiment, the switch 606 includes a forwarding table 702, a layer 2 forwarding engine 704, parsing engine 706, layer 3 shortcut engine 708, shortcut table 710, data port interface unit 720, and router interface 714. The data port interface unit 720 includes a first data port interface 716 tied to the first port 610 and a second data port interface 718 tied to the second port 612. Data packets communicated via the port interfaces 716, 718 within port interface unit 720 are communicated and transmitted over an internal data bus 712. The parsing engine 706 receives packets via the internal bus 712 and, for selected packets, forwards data to a results bus 714. The results bus 714 is coupled to the layer 2 forwarding engine 704 and forwarding table 702, as well as the layer 3 shortcut engine 708 and shortcut table 710. The methods of inspecting packet data units to determine direct connections based on a variety of rules and contexts as illustrated in FIGS. 1 through 5 may be implemented in a software routine within the parsing engine 706. Thus, appropriate packets detected by the parsing engine 706 may be directly routed between interface ports without the added complexity in processing and extra time involved with conventional data packet routing to and from router 608. To implement the data switch 606, each of the components in FIG. 7 may use industry standard network and switching components except for the parsing engine 706 which is modified and expanded in functionality as described herein.

The disclosed system and method for intelligent wireless protocol content load-balancing based on PDU inspection may be deployed to offer packet delivery distinction based on response time, service level agreement or device type. The disclosed system thereby provides a means to create service distinction and varying data carrier quality of service features.

The above disclosed subject matter has been presented by way of example and is to be considered illustrative; the appended claims are intended to cover all modifications, variations and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An apparatus for placement in a communication path between a wireless client device and a plurality of computer network elements, the apparatus comprising:
a data port configured to receive data in accordance with a wireless data protocol; and
a redirection engine coupled to inspect the received data and direct corresponding data in accordance with the wireless data protocol to a particular one of the plurality of computer network elements.

2. The apparatus of claim 1, wherein the particular one of the plurality of computer network elements is a gateway that transforms between the wireless data protocol and a network protocol.

3. The apparatus of claim 1, further comprising a wireless data packet decoding module coupled to the redirection engine.

4. A method of routing wireless data protocol traffic, the method comprising:
receiving a wireless data protocol message;
selecting a first computer network element from amongst plural computer network elements of a computer network accessible by a network information service; and
directing to the first computer network element a data message that corresponds to the received wireless data protocol message.

5. The method of claim 4, wherein the selecting is based at least in part on a load balance criterion.

6 . The method of claim 4, wherein the selecting is based at least in part on information encoded in a header of the received wireless data protocol message.

7. The method of claim 4, wherein the selecting is based at least in part on content of the received wireless data protocol message.

8. The method of claim 4, wherein each of the computer network elements include a gateway that transforms wireless data protocol traffic to network protocol traffic.

9. The method of claim 4, wherein the selecting and directing are performed at a proxy to which the wireless client device directs wireless data protocol traffic.

10. The method of claim 4, wherein the selecting and directing are performed at a switch that receives wireless data protocol traffic from the wireless client device.

11. The method of claim 4, wherein the wireless data protocol includes support for wireless application protocol (WAP) traffic.

12. A system comprising:
a wireless gateway;
a first gateway cluster, the first gateway cluster associated with a first group of computer servers, each of the computer servers in the first group of computer servers having a different internet protocol address; and
a second gateway cluster, the second gateway cluster associated with a second group of computer servers;
wherein the wireless gateway is configured to decode previously encoded wireless data traffic packets to be sent to a selected computer server within one of the first and the second gateway clusters.

13. The system of claim 12, wherein the first gateway cluster is an electronic mail gateway cluster and the second gateway cluster is a wireless application protocol gateway cluster.

14. The system of claim 12, further comprising a third gateway cluster.

15. The system of claim 14, wherein the third gateway cluster is a short message service gateway cluster.

16. The system of claim 12, further comprising a load balancing server, the load balancing server coupled to the first gateway cluster and to the second gateway cluster.

17. The system of claim 16, further comprising a notification server, a wireless data server and storage repository and an internet data server and storage repository, the notification server, wireless data server and storage repository and the internet data server and storage repository responsive to the load balancing server.

18. The system of claim 16, wherein the load balancing server allocates data traffic between the first and the second gateway cluster.

19. A method of processing wireless data traffic, the method comprising:
receiving wireless data traffic at a wireless gateway;
evaluating a data packet within the wireless data traffic at the wireless gateway to determine at least one of language information, user browser type information, and data content type information; and
sending a data request to a particular computer server that is located at an internet protocol address, the particular computer server determined based on at least one of the language information, the user browser type information, and the data content type information.

20. The method of claim 19, further comprising decoding the data packet prior to sending the data request.

21. The method of claim 20, wherein the data packet is a wireless application protocol binary encoded packet data unit.

22. The method of claim 19, wherein the particular computer server is an electronic mail server and further comprising communicating the data request, via an internet data packet message, to the electronic mail server.

23. The method of claim 22, further comprising receiving an electronic mail message from the electronic mail server at the wireless gateway.

24. The method of claim 23, further comprising binary encoding the electronic mail message into a binary encoded form.

25. The method of claim 23, further comprising converting the electronic mail message into wireless application protocol format for transmission by wireless equipment to a remote mobile computing device.

26. A data switching system comprising:
a first data port interface coupled to a first data communication port;
a second data port interface coupled to a second data communication port;
a data packet parsing engine responsive to the first data port interface and the second data port interface, the data packet parsing engine including a wireless data packet evaluation routine to retrieve and to evaluate content contained within the wireless data packet.

27. The system of claim 26, wherein the content includes at least one of language information, user browser type information, and data content type information.

28. The data switching system of claim 26, wherein the data parsing engine further includes a data packet redirection routine to formulate a data packet communication for the wireless data packet, via the second data port interface, to a particular computer server.

29. The data switching system of claim 28, wherein the particular computer server is determined based on at least one of the language information, the user browser type information, and the data content type information.

30. The data switching system of claim 26, further comprising an internal data bus responsive to data packets communicated using the first and the second data ports.

31. The data switching system of claim 26, further comprising a shortcut engine responsive to the parsing engine.

32. The data switching system of claim 31, further comprising a shortcut table responsive to the shortcut engine.

33. The data switching system of claim 26, further comprising a data packet forwarding engine responsive to the parsing engine.

34. The data switching system of claim 33, further comprising a data packet forwarding table responsive to the data packet forwarding engine.

35. A system comprising:
a computer network input to receive an encoded wireless data packet including wireless data content;
a decoding module responsive to the computer network input, the decoding module programmed to decode the encoded wireless data packet and to produce a decoded wireless data packet; and
a logic module programmed to implement a set of rules, the logic module to apply the set of rules to the decoded wireless data packet to determine an internet protocol address identifying a remote computer network element to receive a communication of the wireless data content.

36. The system of claim 35, wherein the logic module determines the internet protocol address by selecting from a set of predetermined addresses, each of the predetermined addressed identifying a distinct server that is a member of a multi-server cluster.

37. The system of claim 35, wherein the decoding module is a binary decoding module and the encoded wireless data packet is binary encoded.

38. The system of claim 35, wherein the encoded wireless data packet is a wireless data packet transmitted from a remote wireless device in accordance with the wireless application protocol (WAP).

39. The system of claim 35, wherein the decoded wireless data packet is transmitted in accordance with a data transmission protocol over a computer network.

40. The system of claim 35, wherein the set of rules includes a rule based on at least one of a language value, a browser type value, and a content type value retrieved from the decoded wireless data packet.

41. The system of claim 35, further comprising a computer server to receive and process the wireless data content.

42. The system of claim 41, wherein the wireless data content includes financial transaction data and the remote computer network element comprises a computer server executing an electronic commerce application to handle a financial transaction based on the financial transaction data.

43. The system of claim 35, wherein the computer network input, the decoding module, and the logic module are all contained within a gateway system and wherein the gateway system is security protected.

44. The system of claim 43, wherein the virtual gateway system is security protected by a data firewall located between the virtual gateway system and a public computer network.

45. A computer program product comprising:
a computer readable media;
a software program within the computer readable media, the software program including a logic routine to apply a set of rules to determine one of a plurality of internet addresses for directing a received wireless data protocol packet based on content of the wireless data packet; and
wherein the computer readable media is selected from the set of a disk, tape or other magnetic, optical, semiconductor or electronic storage medium and a network, wireline, wireless or other communications medium.
